(19) United States
(12) Patent Application Publication
(10) Pub. No.: US 2020/0096415 A1
(43) Pub. Date: Mar. 26, 2020

(54) INSPECTION METHOD FOR THE POSITIONING POINT OF A CONTACT LENS

(71) Applicant: BRIGHTEN OPTIX CORP., Taipei City (TW)

(72) Inventor: I-Tsung WU, Taipei City (TW)

(21) Appl. No.: 16/136,656

(22) Filed: Sep. 20, 2018

(51) Int. Cl. G01M 11/02; G02C 7/04

(52) U.S. Cl. CPC G01M 11/0207; G01B 11/24; G01M 11/0221; G02C 7/047

(57) ABSTRACT

An inspection method for the positioning point of a contact lens is disclosed. In the inspection method, a trial lens comprising inspection points is worn on a patient's eye, and a camera device shoots an eye wearing the trial lens to obtain the shot content, and an electronic device calculates the distances from the limbus of the eye to the inspection points according to the shot content, so as to obtain the position of the positioning point of the eye on the trial lens, and the contact lens is made according to the position of the positioning point, so that an optical center of the contact lens can match the visual axis of the eye. During the inspection process, the eye sight is not blocked or affected by any object, thereby improving accuracy of the inspection for the positioning point.

### BACKGROUND OF THE INVENTION

### 1. Field of the Invention

The present invention generally relates to an inspection method for the positioning point of a contact lens, more particularly to an inspection method in which a camera device is used to shoot an eye worn with a trial lens, and an electronic device is used to calculate the distances from the limbus of the eye to a plurality of inspection points according to a shot content, to obtain a position of the positioning point, so that an optical center of the produced contact lens can match the center of the optical axis.

### 2. Description of the Related Art

Electronic Product Development connect people's daily lives to technology and enhance lifestyle/convenience. Especially the heavy use of computers, communications, and consumer (3C) electronic products results in the popularization of communication and internet technology applications. Many people immerse themselves in the use of 3C electronic products. Mobile phone overuse is seen among certain office workers, students, middle aged and elderly people. People everywhere are beginning to lose patience with the phenomenon known as phubbing: snubbing others in a social setting by checking your phone. Mobile phone overuse can also lead to vision impairment. The result of King's College London study from 2015, exploring the possible link between increased computer and smartphone use and rising rates of myopia. The general way of correcting myopia is wearing glasses, such as frame glasses or contact lenses. Furthermore, the glasses for correcting myopia can also be used to correct other eye refractive errors, such as astigmatism or presbyopia. For example, the contact lens can usually include a central optical zone and a peripheral optical zone with different curvatures. With this configuration of inner and outer surfaces having different curvatures, external light rays can clearly focus on the retina of the eyeball through the central optical zone, and also focus on a predetermined focus in front of the retina through the peripheral optical zone, so that the clear image can be formed in the center of the visual field. Since the minus power of the peripheral optical zone is less than center optical zone, thereby slowing down or retarding myopic progression, and correct myopia in children/adolescents optically at the same time.

Please refer to FIGS. 7 and 8. Before the patient wear a contact lens (a), an optometrist must perform an eye exam to determine the prescription to correct the patient's refractive error. After confirming the patient's prescription, an optometrist will fit the trial lens on the patient's cornea to find the best base curve of the contact lens (a) to fit the curvature of the patient's cornea. After deciding the patent's contact lens prescription, the contact lens (a) can be made by contact lens manufacturer. When the patient wears the contact lens (a), the contact lens (a) should cover the patient's cornea completely. In order to make the contact lens (a), an optical center position (b) of the contact lens (a) is defined at the center position of the contact lens (a), and this center position is an intersection point between the longitudinal axis and the transverse axis, and the curvature of the contact lens (a) is then outwardly extended from the center point, so as to make the contact lens (a) with fixed curvature. However, each patient has different angle Kappa between the pupil axis and the visual axis, and the angle Kappa is approximately between 2° and 11° , and each patient usually has different curve of the cornea and sclera. For this reason, the focus positions of the eyes of different patients are different and not located in a center (c) between the two eyes. Furthermore, because of the influence of ciliary muscles, the temporal side of the sclera is flatter than the nasal side, so the contact lens (a) may shift or skew toward the temporal side after being worn. As a result, if the optical center position (b) of the contact lens (a) is fixed at the center position instead of the actual focus position of the eye, the patient may need more time to adapt the contact lens. Furthermore, the optical center position (b) of the contact lens (a) does not match the line of sight, and this difference between the two points also makes the patient feel uncomfortable when he or she wears the contact lens (a) to see something.

Some manufacturers can provide trial lenses for patients, so that the patient can experience initial lens sensation and an optometrist can check whether the curvature of the trial lens matches the curvature of the patient's cornea; however, the optical center positions of the contact lens and the trial lens are still set in the center positions thereof, as a result, for the patient having different angle Kappa will induce different center of the visual axis, the conventional trial lens still cannot solve the above-mentioned problems and has disadvantages in application. Furthermore, when the patient wears the trial lens, the optometrist can use a slit lamp to observe the amount of the movement of the trial lens worn on the patient's eye, the optometrist only can roughly evaluate the amount of the movement of the trial lens with slit lamp thereof, and find parameters of the contact lens which best match the shape of the patient's cornea, and the final contact lens is made according to the parameters, but the difference in accuracy of how to get the correct center of the visual axis is also increased.

Therefore, what is needed is to develop an inspection method for the positioning point (the center of the visual axis) of a contact lens, to solve above-mentioned problems.

### SUMMARY OF THE INVENTION

In order to solve the aforementioned problems, the inventor develops the inspection method for the positioning point of a contact lens according to the collected data, years of experience, and multiple tests and modifications.

The first objective of the present invention is that the trial lens comprising a plurality of inspection points can be worn on patient's cornea, and the camera device can be used to take a picture or recording a video of the eye worn with the trial lens, to obtain the shot content, and the electronic device is used to calculate the distances from the limbus of the eye to the plurality of inspection points, respectively, according to the shot content, so as to obtain a position of the positioning point of the eye on the trial lens, and the contact lens can be made according to the position of the positioning point of the trial lens, so that the optical center of the contact lens can match the visual axis of the patient's eye, thereby achieving the purpose of making the contact lens matching the focus position of the eye.

The second objective of the present invention is that the plurality of inspection points are disposed on an edge of the trial lens without affecting eye sight of the patient, and prevent the central portion of the trial lens from being blocked or affected by other object, so that the user can indeed see the external environment, and the purpose of improving the accuracy of the inspection of the positioning point can be achieved.

The third purpose of the present invention is that a projection device can be used to project a cross mark on the surface of the trial lens, so that the shot content captured by the camera device can show the cross mark to facilitate the electronic device to calculate the distances, and facilitate the inspector to easily see the cross mark shown in the shot content to check whether the distances calculated by the electronic device are correct, thereby achieving the purpose of improving the accuracy of the position of the positioning point calculation.

The fourth objective of the present invention is that the projection device can be used to project cross mark on the surface of the trial lens without disposing the cross coordinate axis line on the surface of the trial lens directly, so that this manner is applicable to various types of contact lens, and after the positioning point inspection is completed, the projection device and the trial lens can be used for another patient, thereby achieving the reusing and environmentally-friendly purposes.

### BRIEF DESCRIPTION OF THE DRAWINGS

The structure, operating principle and effects of the present invention will be described in detail by way of various embodiments which are illustrated in the accompanying drawings.

FIG. 1 is a flow chart of an inspection method of an embodiment of the present invention.

FIG. 2 is a front plan view of the trial lens of an embodiment of the present invention.

FIG. 3 is a side view of the trial lens worn on the eye, according to an embodiment of the present invention.

FIG. 4 is a schematic view showing usage status of the camera device and the electronic device, according to an embodiment of the present invention.

FIG. 5 is a schematic view showing the trial lens shot by the camera device, according to an embodiment of the present invention.

FIG. 6 is a schematic view of the contact lens worn on the eye.

FIG. 7 is a front plan view of the conventional trial lens.

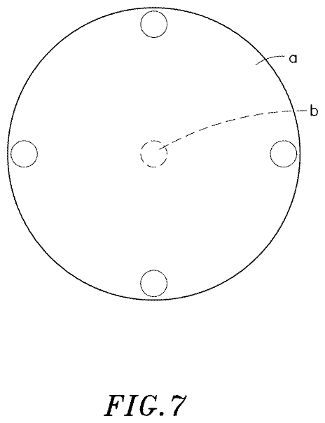

FIG. 8 is a schematic view of operation of inspecting the conventional trial lens.

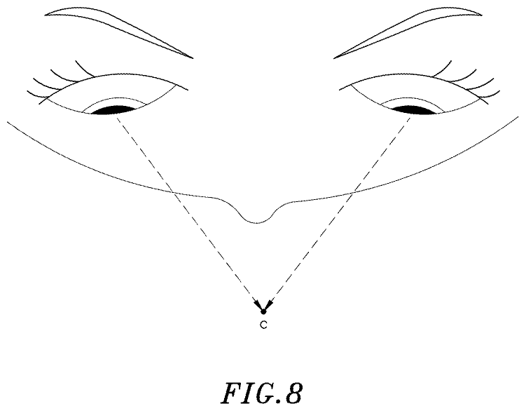

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the ten is ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be understood that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be understood to imply the inclusion of stated elements but not the exclusion of any other elements.

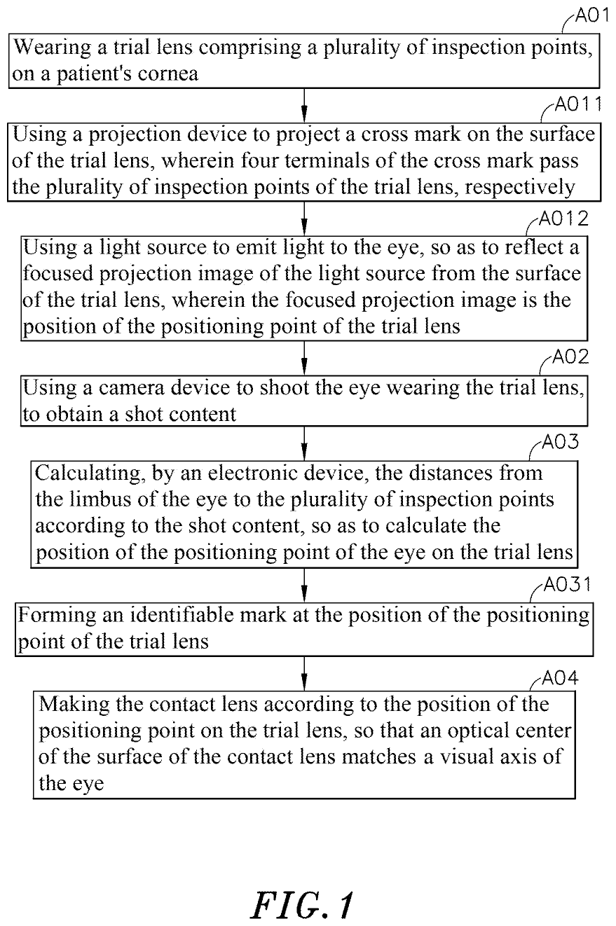

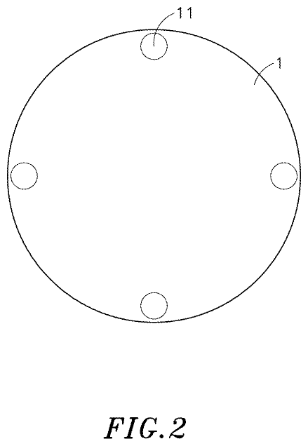

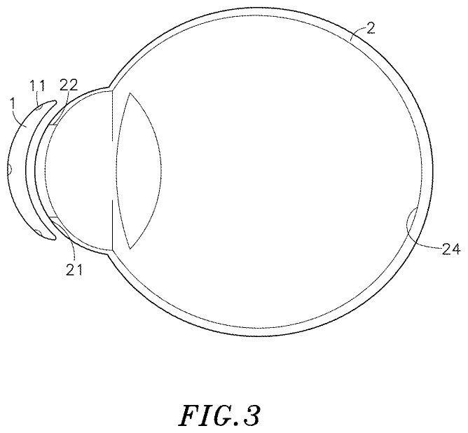

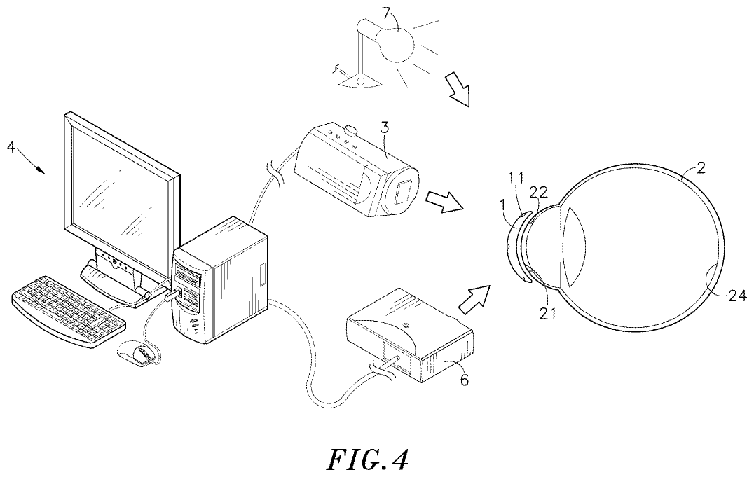

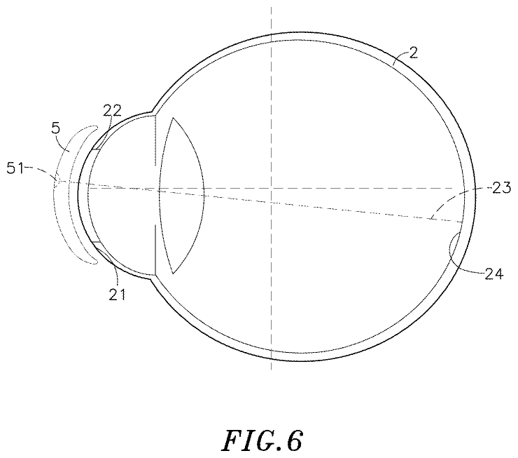

Please refer to FIGS. 1 to 6, which are flow chart of an inspection method of the present invention, front plan view of the trial lens of the present invention, side view of the trial lens worn on the eye, schematic view showing usage status of the camera device and the electronic device, a schematic view showing the trial lens shot by the camera device, and side view of the produced contact lens worn on the eye, according to an embodiment of the present invention, respectively. The inspection method for a trial lens 1 can include following steps.

In step (A01), the trial lens 1 comprising a plurality of inspection points 11 is worn on a cornea 21 of an eye 2.

In step (A02), a camera device 3 is used to shoot the eye 2 wearing with the trial lens 1, to obtain a shot content 31.

In step (A03), an electronic device 4 is operated to calculate the distances from the limbus 22 of the eye 2 to the plurality of inspection points 11, respectively, according to the shot content 31, so as to calculate a position of a positioning point 12 of the eye 2 on the trial lens 1.

In step (A04), a contact lens 5 is made according to the position of the positioning point 12 on the trial lens 1, so that an optical center 51 of the surface of the contact lens 5 can coincide with the visual axis 23 of the eye 2.

In an embodiment, the inspection points 11 of the trial lens 1 can be disposed adjacent to the edge of the trial lens 1, and preferably the inspection points are disposed at the positions without affecting the sight of eye 2; in an preferred embodiment, the number of the inspection points 11 is four, and the four inspection points 11 are disposed on the four axial positions on X axis and Y axis on the surface of the trial lens 1, for example, the four axial positions are the angular positions of 0°, 90°, 180° and 270° respectively on the edge of the trial lens 1; however, in actual application, the plurality of inspection points 11 can be disposed on at least three positions which are separately disposed on the X axis and Y axis, or, the inspection points 11 can comprise at least two inspection points 11 (such as two, three, four, five or six points) disposed at any positions on the edge of the trial lens 1. In other words, at least two inspection points 11 disposed on the edge of the trial lens 1 are required to calculate the distances from the limbus 22 of the eye 2 to the at least two inspection points 11, respectively, for calculating the position of the positioning point 12 of the eye 2 on the trial lens.

In an embodiment, a step (A011) can be performed after the step (A01).

In step (A011), a projection device 6 is used to project a cross mark 61 on the surface of the trial lens 1, and four terminals of the cross mark 61 can pass the plurality of inspection points 11 of the trial lens 1.

The cross mark 61 is projected on the surface of the trial lens 1, so the camera device 3 can obtain the shot content 31 including the cross mark 61, and in the step (A03), with assistance of the cross mark 61, the electronic device 4 can calculate the distances more accurately and the inspector can also see the cross mark 61 shown on the shot content 31 to check whether the distances calculated by the electronic device 4 are correct, so as to improve the accuracy of position calculation for the positioning point 12. Furthermore, the cross mark 61 is projected on the surface of the trial lens 1 without disposing the cross coordinate axis lines on the surface of the trial lens 1 directly, so this manner is applicable to various types of contact lens; furthermore, no cross coordinate axis line is disposed on the trial lens directly, so the trial lens 1 can be reused for another patient after the inspection process for the positioning point 12 is completed, thereby achieving the reuse and environmentally-friendly effect.

In an embodiment, a step (A012) can be performed after the step (A011).

In step (A012), a light source 7 (such as a slip lamp) can be used to emit light to the eye 2, so that the surface of the trial lens 1 can reflect the light emitted from the light source to form a focused projection image of the light source, and the position of the focused projection image is the position of the positioning point 12 on the trial lens 1.

The light source 7 can be used to show the focused projection image on the surface of the trial lens 1, so the inspector can determine the positioning point 12 with assistance of the focused projection image, and calculate the distances in cooperation with the cross mark 61 formed in the step (A011), so as to improve the speed and accuracy in obtaining the positioning point 12.

Preferably, the camera device 3 can be a digital still camera or a camcorder, and the shot content 31 captured by the camera device 3 can be pictures or a video; and, preferably, the shot content 31 can be a video, and the direction, speed, distance of the trial lens 1 movement or the amount of the trial lens 1 rotation on the eye 2 can be obtained according to the video, so that the contact lens 5 can be made according to the aforementioned information, and the optical center 51 of the contact lens 5 can match the visual axis 23 of the eye 2.

In step (A02), the trial lens 1 includes the plurality of inspection points 11 disposed on the surface thereof, so after the camera device 3 captures the shot content 31, the rotation amount before and after lens movement can be obtained according to the plurality of inspection points 11 shown in the shot content 31, and the rotation amount can be used to obtain whether the trial lens 1 is rotated during the inspection process.

In an embodiment, the electronic device 4 can be a desktop computer, a notebook computer, an industrial computer or other electronic device 4 with computation ability, and the electronic device 4 is electrically connected to the camera device 3, so the camera device 3 can transmit the shot content 31 to the electronic device 4. A preset computation system of the electronic device 4 can calculate the distances from the limbus 22 of the eye 2 to the plurality of inspection points 11 of the trial lens 1; for example, distances are A̅B̅ and C̅D̅, and the coordinates of the A point, B point, C point and D point can be (x₁, 0), (x₂, 0), (0, y₁) and (0, y₂), respectively. The distances from the limbus 22 of the eye 2 to the inspection points 11 can be used to calculate the displacement of the trial lens 1 on the cornea 21 of the eye 2. For example, the distances (such as A̅B̅) from the limbus 22 to the two inspection points 11 at the two terminals of the X axis can be the displacement of the trial lens 1 in the direction of X axis, and the distances (such as C̅D̅) from the limbus 22 to the two inspection points 11 at two terminals of the Y axis can be the displacement of the trial lens 1 in the direction of Y axis. The distance from the limbus 22 of the eye 2 to each of the inspection points 11 of the trial lens 1 can be calculated according to the distance formula (that is, A̅B̅=\sqrt{(x₁−x₂)²}, C̅D̅=\sqrt{(y₁−y₂)²}), and the distances from the positioning point 12 to the X axis and Y axis are displacements of the trial lens 1 on the cornea 21 of the eye 2 on the X axis and Y axis, respectively.

In an embodiment, after the positioning point 12 on the trial lens 1 is calculated in the step (A03), a step (A031) can be performed.

In the step (A031), an identifiable mark is formed at the position of the positioning point 12 of the trial lens 1.

After the identifiable mark is formed at the position of the positioning point 12 of the trial lens 1, the positioning point 12 can be easily identified according to the mark, so as to facilitate sequential production of the contact lens 5.

Furthermore, after the step (A04), the preset optical center of the trial lens 1 is moved from an original geometrical center of the trial lens 1 (that is, the center of the curve surface of the trial lens 1) to the position of the positioning point 12, so that the optical center 51 of the contact lens 5 can indeed match the visual axis 23 of the user's eye 2 when the inspected user wears the contact lens 5.

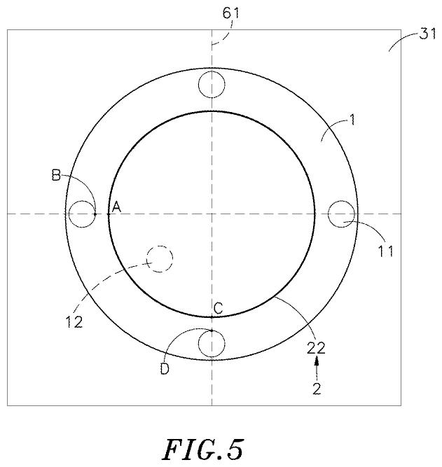

The inspection method of the present invention can be performed before the contact lens 5 is made for the patient. The trial lens 1 with appropriate base curve is selected to wear on the cornea 21 of the user's eye 2, and the patient can blink to adjust the trial lens 1 to make the trial lens 1 suitably cover the cornea 21. After the trial lens 1 is worn on the eye 2, the camera device 3 can shoot the eye 2 worn with the trial lens 1, so as to obtain the shot content 31. The camera device 3 can transmit the shot content 31 to the electronic device 4, and the electronic device 4 then calculate the distances from the limbus 22 of the eye 2 to the plurality of inspection points 11 according to the distance formula; for example, as shown in FIG. 5, the distance from the A point (x₁, 0) to the B point (x₂, 0) is A̅B̅=\sqrt{(x₁−x₂)²}, the distance from C point (0, y₁) to the D point (0, y₂) is C̅D̅=\sqrt{(y₁−y₂)²}, so as to obtain the displacement of the trial lens 1 after the trial lens 1 is worn on the eye. According to the displacement, the actual position of the positioning point 12 of the eye 2 on the trial lens 1 can be obtained, and the positioning point 12 can match the visual axis 23 of the eye 2. Next, the contact lens 5 can be made according to the position of the positioning point 12 on the trial lens 1, so that the optical center 51 of the contact lens 5 can match the visual axis 23 of the patient's eye 2. As a result, the contact lens 5 can shorten the adaptation period after the patient starts to wear the contact lens 5, and the eye 2 can adapt the contact lens 5 more quickly, so that the image can be focused on a retina 24 of the eye 2 correctly without blurring. By using the technical solution of the present invention, the patient wearing the contact lens 5 can see a clear image without feeling uncomfortable, so as to achieve the effect of improving the accuracy of fitting the contact lens 5.

The plurality of inspection points 11 are disposes at edge of the trial lens 1 without affecting sight of the eye, so the central portion of the trial lens 1 is not blocked by other object and the patient's eye sight is not affected, so that the patient can indeed see the external environment, thereby improving the accuracy of the inspection for the positioning point 12.

According to above-mentioned contents, the inspection method of the present invention has advantages below.

First, after the trial lens 1 is worn on the surface of the cornea 21 of the eye 2, the camera device 3 can obtain the shot content 31, and the electronic device 4 calculates the distance from the limbus 22 of the eye 2 to the inspection points 11 according to the shot content 31, to obtain the position of the positioning point 12 of the trial lens 1, and the contact lens 5 can be made according to the positioning point 12, so that the optical center 51 of the contact lens 5 can match the visual axis 23 of the eye 2. By measuring the distance relationship between the visual axis 23 of the eye 2 (that is, the positioning point 12 shown in FIG. 5), the central point of the cornea 21 and the optical center of the trial lens 1 for making the contact lens 5, the image can be correctly focused on the retina 24 of the eye 2 without blurring when the patient wears the contact lens 5, so as to achieve the effect of preventing uncomfortability after the patient wears the contact lens 5.

Secondly, the plurality of inspection points 11 of the trial lens 1 are disposed on the edge of the trial lens 1 without affecting sight of the eye 2, so the central portion of the trial lens 1 is not blocked by other object or the patient's sight is not affected, so that the patient can indeed see the external environment, to improve the accuracy of the inspection for the positioning point 12.

Thirdly the projection device 6 can be used to project the cross mark 61 on the surface of the trial lens 1, so that the shot content 31 captured by the camera device 3 can show the cross mark 61, to facilitate the electronic device 4 to calculate the distances and the inspector to see the cross mark 61 on the shot content 31 for checking whether the distances calculated by the electronic device 4 are correct, thereby achieving the effect of improving the accuracy of the position calculation for the positioning point 12.

Fourthly, the projection device 6 can project the cross mark 61 on the surface of the trial lens 1 without disposing the cross coordinate axis line on the surface of the trial lens 1 directly, so this manner is applicable to various types of contact lens, after the positioning point 12 inspection is completed, the trial lens 1 can be reused for another patient, so as to achieve the reuse and environmentally-friendly effect.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. An inspection method for the positioning point of a contact lens, comprising:
(A01) wearing a trial lens comprising a plurality of inspection points, on a patient's cornea;
(A02) using a camera device to shoot the eye wearing the trial lens, to obtain a shot content;
(A03) calculating, by an electronic device, the distances from the limbus of the eye to the plurality of inspection points according to the shot content, so as to calculate the position of the positioning point of the eye on the trial lens;
(A04) making the contact lens according to the position of the positioning point on the trial lens, so that an optical center of the surface of the contact lens matches a visual axis of the eye.

2. The inspection method according to claim 1, wherein the plurality of inspection points are disposed adjacent to an edge of the trial lens without affecting sight of the eye, and the plurality of inspection points comprise at least two inspection points disposed on the edge of the trial lens.

3. The inspection method according to claim 1, wherein the trial lens comprises four inspection points disposed at four axial positions in directions of X-axis and Y-axis of the trial lens, respectively.

4. The inspection method according to claim 3, wherein the four axial positions are angular positions of 0°, 90°, 180° and 270°.

5. The inspection method according to claim 1, after the step (A01), further comprising:
(A011) using a projection device to project a cross mark on the surface of the trial lens, wherein four terminals of the cross mark pass the plurality of inspection points of the trial lens, respectively.

6. The inspection method according to claim 1, after the step (A011), further comprising:
(A012) using a light source to emit light to the eye, so as to reflect a focused projection image of the light source from the surface of the trial lens, wherein the focused projection image is the position of the positioning point of the trial lens.

7. The inspection method according to claim 1, wherein the camera device is a digital still camera or a camcorder, and the shot content captured by the camera device is pictures or a video.

8. The inspection method according to claim 1, wherein the shot content captured by the camera device is a video, and the direction, speed, distance of trial lens movement or the amount of the trial lens rotation on the eye is calculated according to the video.

9. The inspection method according to claim 1, wherein the electronic device is electrically connected to the camera device, and the camera device transmits the shot content to the electronic device, and the electronic device calculates the distances from the limbus of the eye to the plurality of inspection points of the trial lens, and a difference between the distances from the limbus of the eye to the plurality of inspection points is calculated to obtain the displacement of the trial lens on the cornea of the eye.

10. The inspection method according to claim 1, wherein the distance from the limbus of the eye to each of the plurality of inspection points of the trial lens is calculated according to a distance formula.

11. The inspection method according to claim 1, after the positioning point on the trial lens is calculated, further comprising:
(A031) forming an identifiable mark at the position of the positioning point of the trial lens.
